(19) United States
(12) Patent Application Publication
(10) Pub. No.: US 2018/0038123 A1
(43) Pub. Date: Feb. 8, 2018

(54) VIRTUAL CABIN

(71) Applicant: Daniel Abreu, Perth Amboy, NJ (US)

(72) Inventor: Daniel Abreu, Perth Amboy, NJ (US)

(21) Appl. No.: 15/227,199

(22) Filed: Aug. 3, 2016

(51) Int. Cl. E04H 3/22; H04N 5/64; H04N 9/31; E04B 1/32

(52) U.S. Cl. CPC E04H 3/22; E04B 1/3211; H04N 5/642; H04N 9/3141; E04B 2001/0061

(57) ABSTRACT

A virtual cabin including: a semicircular floor to ceiling screen; a plurality of audio speakers positioned on the floor and ceiling; a ceiling mounted projector; a bass sub-woofer; at least one air vent, where the at least one air vent is adapted to provides airflow through the virtual cabin; and a seating arrangement. The ceiling screen preferably covers all the peripheral views of a room. The projector provides a visual experience associated with the virtual cabin, wherein the audio speakers are strategically place surrounding a perimeter of the floor.

### BACKGROUND OF THE INVENTION

### Field of Invention

The present invention relates to a virtual cabin system that provides a user with a virtual experience.

### Description of Related Art

Individuals frequently may have opportunities to travel and enjoy different locations and experiences. However travel expenses can be costly and difficult to manage with the individual's schedule. Individuals further can utilize books, television, Internet and other means to experience a different location; however, these lack ability to fully immerse the individual into a particular environment. As a result, it would be advantageous to have an environment that's created through a virtual experience where an individual could be fully immersed into an environment.

### SUMMARY OF THE INVENTION

The present invention relates to a virtual cabin including: a semicircular floor to ceiling screen; a plurality of audio speakers positioned on the floor and ceiling; a ceiling mounted projector; a bass sub-woofer; at least one air vent, where the at least one air vent is adapted to provides airflow through the virtual cabin; and a seating arrangement. The ceiling screen preferably covers all the peripheral views of a room. The projector provides a visual experience associated with the virtual cabin, wherein the audio speakers are strategically place surrounding a perimeter of the floor.

### BRIEF DESCRIPTION OF DRAWINGS

FIG. 1 depicts a virtual cabin in accordance with the present invention.

### DETAILED DESCRIPTION

The present invention relates to a virtual cabin experience and system that creates a realistic and virtual experience in a closed environment. This virtual experience allows the user to experience a completely different environment and setting through the use of audio-visual equipment. This virtual system includes a surround sound speaker system with speakers located within an enclosed environment in a dome-shaped room. The speakers are aligned along the floor and ceiling of the room. Further, vents are provided for airflow. A seating arrangement is also available within the virtual cabin along with a projector that projects onto the wall of the virtual room.

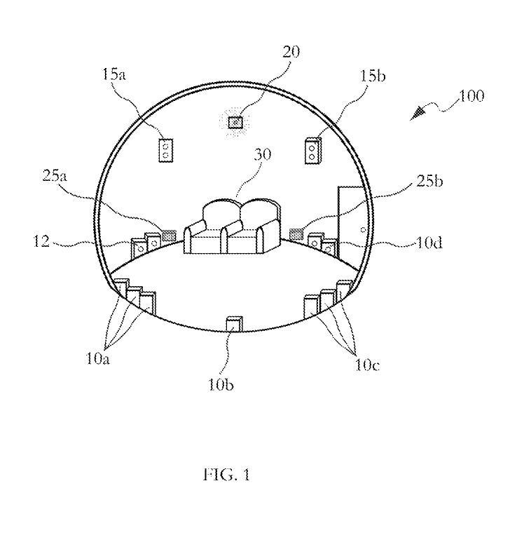

In reference to FIG. 1, a Virtual Cabin 100 is depicted in accordance with the present invention. This view of the Virtual Cabin 100 provides an overview of the design of the virtual cabin in accordance with the present invention. The Virtual Cabin 100 features a semicircular floor to ceiling screen that covers most if not all peripheral views of the room. This set up affords the user with a realistic viewing experience. A Projector 20 is mounted in the ceiling as shown in FIG. 1. The Projector 20 provides the visual experience associated with the Virtual Cabin 100. A series of floor speakers 10a, 10b, 10c, 10d arer strategically place surrounding the perimeter of the floor. A base woofer 12 is also provided so that a full range of sound may be provided within the room. In addition to the floor speakers 10a through 10d ceiling speakers 15a, 15b are also placed along the ceiling to provide a complete audio experience for the user of the Virtual Cabin 100. A seating arrangement 30 is also provided. The seating arrangement 30 provides comfortable seating for users of the virtual cabin. Although depicted in FIG. 1 as two seats the room may be expanded to provide additional seating as needed. Also essential for the virtual cabin is venting shown with the vents 25a, 25b that provides adequate airflow through the virtual cabin.

As a result, a user may activate the projector display that is preloaded with programming and associated audio sound for the virtual experience. This Virtual Cabin 100 helps to give the user a realistic feeling of the virtual experience in the Virtual Cabin 100. Temperature may be controlled through the venting system and sound provided through the audio systems as described above. Further, in an additional embodiment of the present invention a fragrance dispenser may be available to provide a particular fragrance associated with the particular virtual experience. The instant invention has been shown and described in what it considers to be the most practical and preferred embodiments. It is recognized, however, that departures may be made there from within the scope of the invention and that obvious modifications will occur to a person skilled in the art.

What is claimed is:

1. A virtual cabin comprising:
a. a semicircular floor to ceiling screen;
b. a plurality of audio speakers positioned on the floor and ceiling;
c. a ceiling mounted projector;
d. a bass sub woofer;
e. at least one air vent, where the at least one air vent is adapted to provides airflow through the virtual cabin; and
f. a seating arrangement.

2. The virtual cabin according to claim 1, where the ceiling screen covers all the peripheral views of a room.

3. The virtual cabin according to claim 1, wherein the projector provides a visual experience associated with the virtual cabin.

4. The virtual cabin according to claim 1, wherein the audio speakers are strategically place surrounding a perimeter of the floor.

5. The virtual cabin according to claim 1, wherein the seating arrangement includes at least two seats.
